(19) United States
(12) Patent Application Publication
(10) Pub. No.: US 2024/0329485 A1
(43) Pub. Date: Oct. 3, 2024

(54) Piezo-electrophoretic films and displays, and methods for manufacturing the same

(71) Applicant: E Ink Corporation, Billerica, MA (US)

(72) Inventors: Haiyan GU, Fremont, CA (US); HongMei ZANG, Fremont, CA (US); Yuriy Borisovich MATUS, Pleasanton, CA (US)

(21) Appl. No.: 18/680,895

(22) Filed: May 31, 2024

Related U.S. Application Data
(63) Continuation-in-part of application No. 18/394,980, filed on Dec. 22, 2023.
Application No. 18/394,980 is a continuation of application No. 17/505,796, filed on Oct. 20, 2021, now Pat. No. 11,892,740.
Application No. 17/505,796 is a continuation of application No. 16/415,022, filed on May 17, 2019, now Pat. No. 11,181,799.
(60) Provisional application No. 62/673,092, filed on May 17, 2018.
(60) Provisional application No. 62/727,033, filed on Sep. 5, 2018.
(60) Provisional application No. 63/579,377, filed on Aug. 29, 2023.

(51) Int. Cl. G02F 1/167; G02F 1/1675; G02F 1/16755; G02F 1/1676

(52) U.S. Cl. CPC G02F 1/167; G02F 1/16755; G02F 1/1676; G02F 2001/1678; G02F 2202/10

(57) ABSTRACT

Low voltage piezo-electrophoretic films and displays including low profile piezo-electrophoretic films. Piezo-electrophoretic displays having a layer of electrophoretic material, a first conductive layer, and a piezoelectric material positioned between the layer of electrophoretic material and the first conductive layer, where the piezoelectric material overlaps with a portion of the layer of electrophoretic material, and a portion of the first conductive layer overlaps with the rest of the electrophoretic material. Such films and displays exhibit a high contrast ratio and are useful as security markers, authentication films, or sensors. The films and displays are generally flexible. Some are less than 100 μm in thickness. Some are less than 50 μm in thickness. Piezo-electrophoretic films and displays formed according to the technology described herein do not require an external power source to change optical state.

### CROSS-REFERENCE TO RELATED APPLICATIONS

This application is a continuation-in-part of U.S. application Ser. No. 18/394,980, filed Dec. 22, 2023 (Publication No. 2024-0168356), which is a continuation of U.S. application Ser. No. 17/505,796, filed Oct. 20, 2021 (Publication No. 2022-0035219; now U.S. Pat. No. 11,892,740), which is a continuation of U.S. application Ser. No. 16/415,022, filed May 17, 2019 (Publication No. 2019-0353973; now U.S. Pat. No. 11,181,799), which is related and claims priority to U.S. Provisional Application No. 62/673,092, filed May 17, 2018, and U.S. Provisional Application No. 62/727,033, filed Sep. 5, 2018. This application is also related and claims priority to U.S. Provisional Application No. 63/579,377, filed Aug. 29, 2023.

The entire disclosures of the aforementioned applications and all other applications or publications referred to below are incorporated by reference herein in their entireties.

### FIELD OF THE INVENTION

The subject matter disclosed herein relates to low-profile piezo-electrophoretic displays which may be activated or driven without being connected to a power source, and methods for their manufacture.

### BACKGROUND OF THE INVENTION

Non-emissive displays convey information using contrast differences, which are achieved by varying the reflectance of different frequencies of light; they are thus distinct from traditional emissive displays, which stimulate the eye by emitting light. One type of non-emissive display is an electrophoretic display or “EPD,” which utilizes the phenomenon of electrophoresis to achieve contrast. Electrophoresis refers to movement of charged pigment particles in an applied electric field. When electrophoresis occurs in a liquid, the particles move with a velocity determined primarily by the viscous drag experienced by the pigment particles, their charge, the dielectric properties of the liquid, and the magnitude of the applied electric field.

One type of electrophoretic display utilizes charged pigment particles of one color suspended in a dielectric liquid medium of a different color (that is, light reflected by the particles is absorbed by the liquid). The suspension is housed in a cell located between (or partly defined by) a pair of oppositely-disposed electrodes, one of which is typically transparent. When the electrodes are operated to apply a DC or pulsed field across the medium, the pigment particles migrate toward the electrode having the opposite polarity of the charged pigment particles. The result is a visually observable color change. In particular, when a sufficient number of the particles reach the transparent electrode, the color of the pigment particles is seen from the viewing side of the display. Alternatively, if the particles are drawn to the other electrode, the color of the liquid medium dominates the viewing side of the display instead.

Many electrophoretic displays incorporate an electrophoretic fluid that includes a non-polar solvent and two or more sets of charged pigment particles. The particles can have different optical properties (colors), different charges (positive or negative), different charge magnitudes (zeta potentials), and/or different absorptive properties (broadly light-absorbing or broadly light-reflecting, or selectively-absorbing or selectively reflecting). In the instance where there are multiple particle sets with opposite charge polarities, application of an electric field may cause a pigment particle of one set to appear at the viewing surface while the other pigment particle is driven away from the viewing surface.

Many electrophoretic displays are bi-stable meaning the optical state of such displays persists even after the activating electric field is removed. Bistability is primarily a result of induced dipole charge layers forming around the charged pigments due to complex interactions between the pigments, charge control agents, and free polymers dispersed in the solvent. A bistable display can last for years in the last-addressed optical state before being switched again with the application of a new driving field.

Driving an electrophoretic display requires a power source such as a battery to provide power to the display and/or its driving circuitry. For example, a battery may be used to supply power to a driver IC that in turn generates an electric field to energize the display's electrodes. The power source could also be, e.g., a photovoltaic cell, a fuel cell, or a power supply that receives power from a wall outlet.

In all of these examples, some type of driving circuitry is required to provide an electrical pathway between the power source and the electrodes. Typically, the circuitry also includes control elements (e.g., switches, transistors, etc.), and a number of discrete components (e.g., resistors, capacitors, etc.).

In most instances, the circuitry used in conventional displays is complex, but fairly well-known to those skilled in display technology. However, incorporating such circuitry can limit the display's tolerance to mechanical stresses such as flexing and/or twisting. Furthermore, the presence of the additional components typically necessitates an increase in the overall physical dimensions of the fully-assembled display.

The physical limitations imposed on a display by the addition of a power source and driving circuitry can render such displays unsuitable for an increasing number of applications for which it is desirable to reduce the overall thickness of the display. Accordingly, in an effort to reduce display thickness, some electrophoretic displays utilize a lower-profile piezoelectric element that creates charge in response to mechanical strain or thermal cycling. However, the thickness of a layer of piezoelectric material generally has a direct correlation to the amplitude of the voltage the piezoelectric material is capable of generating in response to mechanical stress. That is, reducing the thickness of the piezoelectric material also reduces the magnitude of the voltage the piezoelectric material generates under stress (and vice versa). Accordingly, in order to generate a voltage potential large enough to cause sufficient movement of charged pigment particles needed to move a sufficient amount to achieve acceptable contrast ratio, conventional piezo-electrophoretic displays have typically incorporated a layer of piezoelectric material too thick for such displays to be viable for use in applications requiring them to be durable and substantially unnoticeable when incorporated into thin, low-profile final products such as paper or bank notes.

### SUMMARY OF THE INVENTION

There is therefore a need for piezo-electrophoretic displays that are sufficiently thin and durable to be used for applications requiring low-profile final products while also providing a high contrast ratio.

According to one aspect of the subject matter disclosed herein, an electro-optic display may include a layer of electrophoretic material; a first conductive layer; and a piezoelectric material positioned between the layer of electrophoretic material and the first conductive layer, the piezoelectric material overlaps with a portion of the layer of electrophoretic material, and a portion of the first conductive layer overlaps with the rest of the electrophoretic material.

In one aspect, the invention features a method for making a piezo-electrophoretic display. The method includes depositing a first electrically-conductive material on a first substrate to form a first electrode, and bonding the first electrode with a first surface of a layer of electrophoretic material. The method also includes depositing a piezoelectric material on a second surface of the layer of electrophoretic material, where the piezoelectric material overlaps with a first surface area of the second surface of the layer of electrophoretic material. The method also includes depositing a second electrically-conductive material to form a second electrode, where the second electrode is formed to overlap with all of the piezoelectric material and a second surface area of the second surface of the layer of electrophoretic material.

In some embodiments, the layer of electrophoretic material includes a first portion of electrophoretic material overlapping the first surface area, and a second portion of electrophoretic material overlapping the second surface area. In some embodiments, the first portion of electrophoretic material has a first electrical resistance and the second portion of electrophoretic material has a second electrical resistance.

In some embodiments, the layer of electrophoretic material includes a first portion of electrophoretic material having a first electrical resistance corresponding to a first volume of electrophoretic material overlapping the first surface area, and a second portion of electrophoretic material having a second electrical resistance corresponding to a second volume of electrophoretic material overlapping the second surface area. In some embodiments, a value of the first electrical resistance and a value of the second electrical resistance are based on a ratio of the first surface area to the second surface area.

In some embodiments, applying mechanical stress to the piezoelectric material generates a first voltage across the first portion of the electrophoretic material and a second voltage across the second portion of the electrophoretic material, wherein the first voltage and the second voltage have opposite polarities.

In some embodiments, bonding includes: coating the first electrode with a microcell precursor material; embossing the microcell precursor material to create a layer of microcells, where the microcells have a bottom, a plurality of walls, and a top opening; filling the microcells with an electrophoretic medium through the top opening; and sealing off the top opening of the filled microcells with a water-soluble polymer to create a scaling layer.

In some embodiments, the method also includes applying a primer to the microcell precursor material before embossing the microcell precursor material. In some embodiments, the method also includes activating the microcells with a vapor plasma treatment before filling the microcells with the electrophoretic medium. In some embodiments, the electrophoretic medium comprises a non-polar fluid and charged pigment particles that move toward or away from the piezoelectric material when the piezoelectric material is mechanically stressed, wherein the non-polar fluid and charged pigment particles are sealed in the microcells with the sealing layer.

In some embodiments, the method also includes applying a layer of adhesive material between the piezoelectric material and the first surface area of the second surface of the layer of electrophoretic material, where the layer of adhesive material has a resistivity between 10² ohm*cm and 10¹² ohm*cm. In some embodiments, the method also includes applying a layer of adhesive material between the piezoelectric material and the first surface area of the second surface of the layer of electrophoretic material, wherein the layer of adhesive material has a resistivity at least one order of magnitude greater than the first and second electrodes.

In some embodiments, the method also includes depositing a dielectric layer prior to depositing the second electrically-conductive material, where the dielectric layer is formed to overlap with all of the piezoelectric material and the second surface area of the second surface of the layer of electrophoretic material, and wherein the second electrode is formed to overlap with all of the dielectric layer. In some embodiments, the dielectric layer has a resistivity between 10² ohm*cm and 10¹² ohm*cm. In some embodiments, the dielectric layer has a resistivity at least one order of magnitude greater than the first and second electrodes.

In some embodiments, the method also includes printing one or more images onto at least one of the first electrode and the second electrode. In some embodiments, the method also includes affixing the piezo-electric display to a target object chosen from the group consisting of paper, a bank note, and a currency bill.

### BRIEF DESCRIPTION OF DRAWINGS

FIG. 1A is a schematic cross sectional view of an exemplary piezo-electrophoretic display in accordance with the subject matter disclosed herein.

FIG. 1B is a schematic cross section illustrating additional properties of a piezo-electrophoretic display in accordance with the subject matter disclosed herein.

FIG. 1C is a perspective view illustrating additional properties of a piezo-electrophoretic display in accordance with the subject matter disclosed herein.

FIG. 2 illustrates an exemplary equivalent circuit of a piezo-electrophoretic display in accordance with the subject matter disclosed herein.

FIG. 3A is a cross sectional view of another exemplary display in accordance with the subject matter disclosed herein.

FIG. 3B is a cross sectional view along the line C1 of the display illustrated in FIG. 3A.

FIG. 3C is a cross sectional view along the line C2 of the display illustrated in FIG. 3A.

FIG. 3D illustrate yet another embodiment of a display in accordance with the subject matter presented herein.

FIG. 4 is a schematic cross-sectional view of an exemplary piezo-electrophoretic display in accordance with the subject matter disclosed herein.

FIG. 5 is a cross section view of another exemplary display in accordance with the subject matter disclosed herein.

FIG. 6 illustrates one embodiment of a piezo electrophoretic display with a jigsaw pattern in accordance with the subject matter disclosed herein.

FIG. 7 illustrates yet another embodiment of a piezo electrophoretic display having a pattern in accordance with the subject matter disclosed herein.

FIG. 8 illustrates a piezo electrophoretic display in accordance with the subject matter disclosed herein being used as part of a currency bill for anti-counterfeiting purposes.

FIG. 9 illustrate a cross section of yet another embodiment of a piezoelectric display in accordance with the subject matter disclosed herein.

FIG. 10 is a cross sectional view of a piezoelectric display in accordance with the subject matter disclosed herein having a barrier layer.

FIG. 11A is a top view of a micro-cell layer.

FIG. 11B is a cross sectional view of the micro-cell layer illustrated in FIG. 10A.

FIGS. 12A and 12B illustrate another embodiment of an electrophoretic display in accordance with the subject matter disclosed herein.

FIGS. 13A and 13B illustrate yet another embodiment of an electrophoretic display in accordance with the subject matter disclosed herein.

FIG. 14A illustrate an addition embodiment of an electrophoretic display with printed images or shapes in accordance with the subject matter disclosed herein.

FIGS. 14B-14E illustrate the display of FIG. 14A in use in accordance with the subject matter disclosed herein.

FIG. 15A illustrate yet another embodiment of an electrophoretic display with printed images or shapes in accordance with the subject matter disclosed herein.

FIGS. 15B-15C illustrate the display of FIG. 15A in use in accordance with the subject matter disclosed herein.

### DETAILED DESCRIPTION OF THE INVENTION

Low-profile piezo-electrophoretic films and displays and methods for manufacturing such films and displays are disclosed herein. The low-profile films and displays described below achieve a high contrast ratio, and are useful as security markers, authentication films, or sensors. The films and displays described herein are generally flexible. Some films are less than 100 μm in thickness. In some embodiments, the piezo-electrophoretic films are less than 50 μm and foldable without breaking. Displays formed according to the subject matter disclosed herein do not require an external power source.

The term “electro-optic,” as applied to a material or a display, is used herein in its conventional meaning in the imaging art to refer to a material having first and second display states differing in at least one optical property, the material being changed from its first to its second display state by application of an electric field to the material. Although the optical property is typically color perceptible to the human eye, it may be another optical property, such as optical transmission, reflectance, luminescence or, in the case of displays intended for machine reading, pseudo-color in the sense of a change in reflectance of electromagnetic wavelengths outside the visible range.

The terms “bistable” and “bistability” are used herein in their conventional meaning in the art to refer to displays comprising display elements having first and second display states differing in at least one optical property, and such that after any given element has been driven, by means of an addressing pulse of finite duration, to assume either its first or second display state, after the addressing pulse has terminated, that state will persist for at least several times, for example at least four times, the minimum duration of the addressing pulse required to change the state of the display element. It is shown in U.S. Pat. No. 7,170,670 that some particle-based electrophoretic displays capable of gray scale are stable not only in their extreme black and white states but also in their intermediate gray states, and the same is true of some other types of electro-optic displays. This type of display is properly called “multi-stable” rather than bistable, although for convenience the term “bistable” may be used herein to cover both bistable and multi-stable displays.

The term “gray state” is used herein in its conventional meaning in the imaging art to refer to a state intermediate two extreme optical states of a pixel, and does not necessarily imply a black-white transition between these two extreme states. For example, several of the E Ink patents and published applications referred to below describe electrophoretic displays in which the extreme states are white and deep blue, so that an intermediate “gray state” would actually be pale blue. Indeed, as already mentioned, the change in optical state may not be a color change at all. The terms “black” and “white” may be used hereinafter to refer to the two extreme optical states of a display, and should be understood as normally including extreme optical states which are not strictly black and white, for example, the aforementioned white and dark blue states. The term “monochrome” may be used hereinafter to denote a display or drive scheme which only drives pixels to their two extreme optical states with no intervening gray states.

The term “pixel” is used herein in its conventional meaning in the display art to mean the smallest unit of a display capable of generating all the colors which the display itself can show. In a full color display, typically each pixel is composed of a plurality of sub-pixels each of which can display less than all the colors which the display itself can show. For example, in most conventional full color displays, each pixel is composed of a red sub-pixel, a green sub-pixel, a blue sub-pixel, and optionally a white sub-pixel, with each of the sub-pixels being capable of displaying a range of colors from black to the brightest version of its specified color.

Several types of electro-optic displays are known. One type of electro-optic display uses an electrochromic medium, for example an electrochromic medium in the form of a nanochromic film comprising an electrode formed at least in part from a semi-conducting metal oxide and a plurality of dye molecules capable of reversible color change attached to the electrode; see, for example O'Regan, B., et al., Nature 1991, 353, 737; and Wood, D., Information Display, 18 (3), 24 (March 2002). See also Bach, U., et al., Adv. Mater., 2002, 14 (11), 845. Nanochromic films of this type are also described, for example, in U.S. Pat. Nos. 6,301,038; 6,870,657; and 6,950,220. This type of medium is also typically bistable.

Another type of electro-optic display is an electro-wetting display developed by Philips and described in Hayes, R. A., et al., “Video-Speed Electronic Paper Based on Electrowetting”, Nature, 425, 383-385 (2003). It is shown in U.S. Pat. No. 7,420,549 that such electro-wetting displays can be made bistable.

One type of electro-optic display, which has been the subject of intense research and development for a number of years, is the particle-based electrophoretic display, in which a plurality of charged particles move through a fluid under the influence of an electric field. Electrophoretic displays can have attributes of good brightness and contrast, wide viewing angles, state bistability, and low power consumption when compared with liquid crystal displays.

An electrophoretic display normally comprises a layer of electrophoretic material and at least two other layers disposed on opposed sides of the electrophoretic material, one of these two layers being an electrode layer. In most such displays both the layers are electrode layers, and one or both of the electrode layers are patterned to define the pixels of the display. For example, one electrode layer may be patterned into elongate row electrodes and the other into elongate column electrodes running at right angles to the row electrodes, the pixels being defined by the intersections of the row and column electrodes. Alternatively, and more commonly, one electrode layer has the form of a single continuous electrode and the other electrode layer is patterned into a matrix of pixel electrodes, each of which defines one pixel of the display. In another type of electrophoretic display, which is intended for use with a stylus, print head or similar movable electrode separate from the display, only one of the layers adjacent the electrophoretic layer comprises an electrode, the layer on the opposed side of the electrophoretic layer typically being a protective layer intended to prevent the movable electrode damaging the electrophoretic layer.

Numerous patents and applications assigned to or in the names of the Massachusetts Institute of Technology (MIT) and E Ink Corporation describe various technologies used in encapsulated electrophoretic and other electro-optic media. Such encapsulated media comprise numerous small capsules, each of which itself comprises an internal phase containing electrophoretically-mobile particles in a fluid medium, and a capsule wall surrounding the internal phase. Typically, the capsules are themselves held within a polymeric binder to form a coherent layer positioned between two electrodes. The technologies described in these patents and applications include:
(a) Electrophoretic particles, fluids and fluid additives; see for example U.S. Pat. Nos. 7,002,728 and 7,679,814;
(b) Capsules, binders and encapsulation processes; see for example U.S. Pat. Nos. 6,922,276 and 7,411,719;
(c) Films and sub-assemblies containing electro-optic materials; see for example U.S. Pat. Nos. 6,982,178 and 7,839,564;
(d) Backplanes, adhesive layers and other auxiliary layers and methods used in displays; see for example U.S. Pat. Nos. 7,116,318 and 7,535,624;
(c) Color formation and color adjustment; see for example U.S. Pat. Nos. 7,075,502 and 7,839,564;
(f) Methods for driving displays; see for example U.S. Pat. Nos. 7,012,600 and 7,453,445;
(g) Applications of displays; see for example U.S. Pat. Nos. 7,312,784 and 8,009,348;
(h) Non-electrophoretic displays, as described in U.S. Pat. Nos. 6,241,921; 6,950,220; 7,420,549 and 8,319,759; and U.S. Patent Application Publication No. 2012/0293858;
(i) Microcell structures, wall materials, and methods of forming microcells; see for example U.S. Pat. Nos. 7,072,095 and 9,279,906; and
(j) Methods for filling and sealing microcells; see for example U.S. Pat. Nos. 7,144,942 and 7,715,088.

Many of the aforementioned patents and applications recognize that the walls surrounding the discrete microcapsules in an encapsulated electrophoretic medium could be replaced by a continuous phase, thus producing a so-called polymer-dispersed electrophoretic display, in which the electrophoretic medium comprises a plurality of discrete droplets of an electrophoretic fluid and a continuous phase of a polymeric material, and that the discrete droplets of electrophoretic fluid within such a polymer-dispersed electrophoretic display may be regarded as capsules or microcapsules even though no discrete capsule membrane is associated with each individual droplet; see for example, the aforementioned U.S. Pat. No. 6,866,760. Accordingly, for purposes of the present application, such polymer-dispersed electrophoretic media are regarded as sub-species of encapsulated electrophoretic media.

A related type of electrophoretic display is a so-called “microcell electrophoretic display,” also known as MICROCUP®. In a microcell electrophoretic display, the charged particles and the fluid are not encapsulated within microcapsules but instead are retained within a plurality of cavities formed within a carrier medium, typically a polymeric film. See, for example, U.S. Pat. Nos. 6,672,921 and 6,788,449, both of which are incorporated herein by reference in their entireties.

Although electrophoretic media are often opaque (since, for example, in many electrophoretic media, the particles substantially block transmission of visible light through the display) and operate in a reflective mode, many electrophoretic displays can be made to operate in a so-called “shutter mode” in which one display state is substantially opaque and one is light-transmissive. See, for example, U.S. Pat. Nos. 5,872,552; 6,130,774; 6,144,361; 6,172,798; 6,271,823; 6,225,971; and 6,184,856. Dielectrophoretic displays, which are similar to electrophoretic displays but rely upon variations in electric field strength, can operate in a similar mode; see U.S. Pat. No. 4,418,346. Other types of electro-optic displays may also be capable of operating in shutter mode. Electro-optic media operating in shutter mode may be useful in multi-layer structures for full color displays; in such structures, at least one layer adjacent the viewing surface of the display operates in shutter mode to expose or conceal a second layer more distant from the viewing surface.

An encapsulated electrophoretic display typically does not suffer from the clustering and settling failure mode of traditional electrophoretic devices and provides further advantages, such as the ability to print or coat the display on a wide variety of flexible and rigid substrates. (Use of the word “printing” is intended to include all forms of printing and coating, including, but without limitation: pre-metered coatings such as patch die coating, slot or extrusion coating, slide or cascade coating, curtain coating; roll coating such as knife over roll coating, forward and reverse roll coating; gravure coating; dip coating; spray coating; meniscus coating; spin coating; brush coating; air knife coating; silk screen printing processes; electrostatic printing processes; thermal printing processes; ink jet printing processes; electrophoretic deposition (See U.S. Pat. No. 7,339,715); and other similar techniques.) Thus, the resulting display can be flexible. Further, because the display medium can be printed, using a variety of methods, the display itself can be made inexpensively.

The aforementioned U.S. Pat. No. 6,982,178 describes a method of assembling a solid electro-optic display (including an encapsulated electrophoretic display) which is well adapted for mass production. Essentially, this patent describes a so-called “front plane laminate” (“FPL”) which comprises, in order, a light-transmissive electrically-conductive layer; a layer of a solid electro-optic medium in electrical contact with the electrically-conductive layer; an adhesive layer; and a release sheet. Typically, the light-transmissive electrically-conductive layer will be carried on a light-transmissive substrate, which is preferably flexible, in the sense that the substrate can be manually wrapped around a drum (say) 10 inches (254 mm) in diameter without permanent deformation. The term “light-transmissive” is used in this patent and herein to mean that the layer thus designated transmits sufficient light to enable an observer, looking through that layer, to observe the change in display states of the electro-optic medium, which will normally be viewed through the electrically-conductive layer and adjacent substrate (if present); in cases where the electro-optic medium displays a change in reflectivity at non-visible wavelengths, the term “light-transmissive” should of course be interpreted to refer to transmission of the relevant non-visible wavelengths. The substrate will typically be a polymeric film, and will normally have a thickness in the range of about 1 to about 25 mil (25 to 634 μm), preferably about 2 to about 10 mil (51 to 254 μm). The electrically-conductive layer is conveniently a thin metal or metal oxide layer of, for example, aluminum or ITO, or may be a conductive polymer. Poly (ethylene terephthalate) (PET) films coated with aluminum or ITO are available commercially, for example as “aluminized Mylar” (“Mylar” is a Registered Trade Mark) from E.I. du Pont de Nemours & Company, Wilmington DE, and such commercial materials may be used with good results in the front plane laminate.

Assembly of an electro-optic display using such a front plane laminate may be effected by removing the release sheet from the front plane laminate and contacting the adhesive layer with the backplane under conditions effective to cause the adhesive layer to adhere to the backplane, thereby securing the adhesive layer, layer of electro-optic medium and electrically-conductive layer to the backplane. This process is well-adapted to mass production since the front plane laminate may be mass produced, typically using roll-to-roll coating techniques, and then cut into pieces of any size needed for use with specific backplanes.

U.S. Pat. No. 7,561,324 describes a so-called “double release sheet” which is essentially a simplified version of the front plane laminate of the aforementioned U.S. Pat. No. 6,982,178. One form of the double release sheet comprises a layer of a solid electro-optic medium sandwiched between two adhesive layers, one or both of the adhesive layers being covered by a release sheet. Another form of the double release sheet comprises a layer of a solid electro-optic medium sandwiched between two release sheets. Both forms of the double release film are intended for use in a process generally similar to the process for assembling an electro-optic display from a front plane laminate already described, but involving two separate laminations. Typically, in a first lamination the double release sheet is laminated to a front electrode to form a front sub-assembly, and then in a second lamination the front sub-assembly is laminated to a backplane to form the final display, although the order of these two laminations could be reversed if desired.

The subject matter presented herein relates to structural designs and manufacturing processes for piezo-electrophoretic films and displays that do not need a power supply (e.g., battery, wired power supply, photovoltaic source, etc.) in order for the display to operate. The assembly process is therefore simplified, and the thickness of such displays is substantially less than that of conventional piezo-electrophoretic displays.

Piezoelectricity is the charge which accumulates in a solid material in response to applied mechanical stress. Suitable materials for the subject matter disclosed herein may include polyvinylidene fluoride (PVDF), quartz (SiO2), berlinite (AlPO4), gallium orthophosphate (GaPO4), tourmaline, barium titanate (BaTiO3), lead zirconate titanate (PZT), zinc oxide (ZnO), aluminum nitride (AlN), lithium tantalite, lanthanum gallium silicate, potassium sodium tartrate and any other known piezoelectric materials.

Piezo-electrophoretic films and piezo-electrophoretic displays described herein use the piezoelectricity to drive the charged pigment particles of an electrophoretic medium toward one of the display electrodes. Thus, manipulating or physically straining the piezoelectric material when coupled to an electrophoretic media layer can cause the color of the electrophoretic material at the viewing surface to change. For example, by bending or introducing other mechanical stress to a piece of piezoelectric material, voltage may be generated across the electrophoretic medium and this voltage can be utilized to cause movement of the color pigment particles of the electrophoretic medium. If only portions of an electrophoretic media layer are coupled to a piezoelectric material, an electrophoretic medium having two types of oppositely-charged pigments can be used to create patterns with high contrast ratios. As used herein, the term “contrast ratio” or “CR” for an electro-optic display (e.g., an electrophoretic display) is defined as the ratio of the luminance of the brightest color (white) to that of the darkest color (black) that the display is capable of producing. Normally, a high contrast ratio is a desired aspect of an electro-optic display.

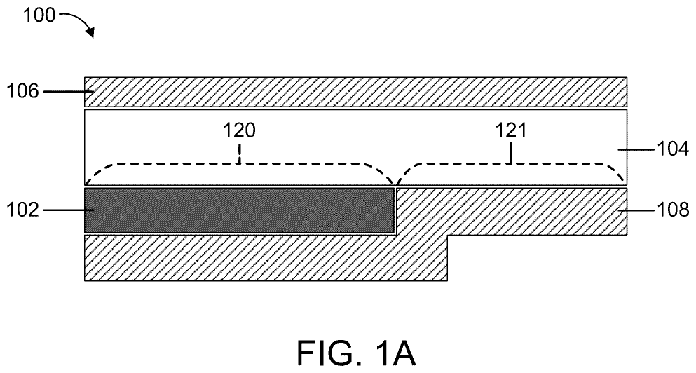

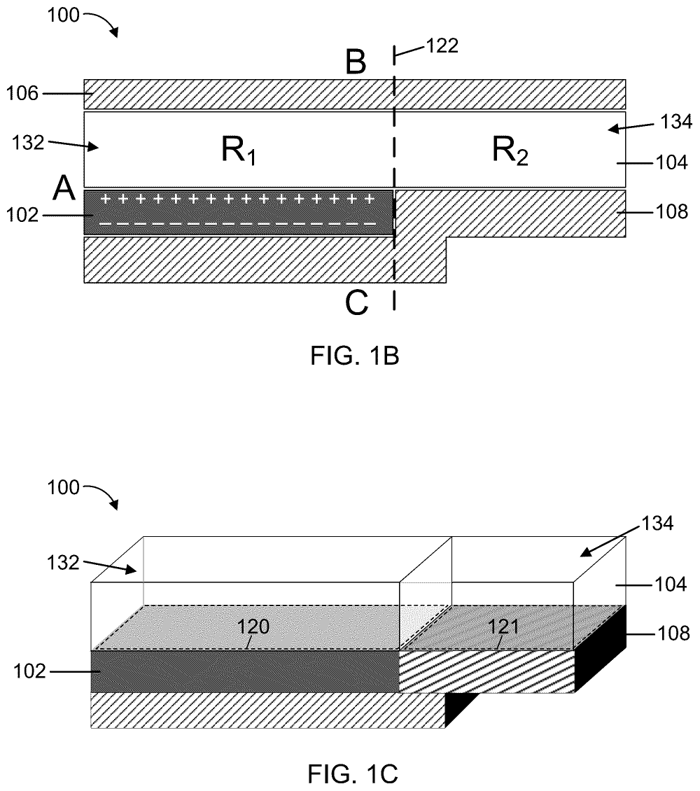

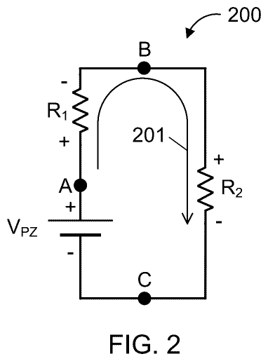

FIG. 1A illustrates a cross sectional view of an exemplary piezo-electrophoretic display 100 using a piezoelectric material 102 to generate a voltage potential sufficient to drive charged pigment particles within a layer of electrophoretic material 104 in accordance with the subject matter disclosed herein. Display 100 includes a first electrode, electrode 106, overlapping or covering a first surface of the layer of electrophoretic material 104. Display 100 further includes the piezoelectric material 102 overlapping or covering a first portion of a second surface of the layer of electrophoretic material 104, as denoted by surface area 120 in FIG. 1A. A second electrode, electrode 108, overlaps with all of the piezoelectric material 102, and a second portion of the second surface of the layer of electrophoretic material 104, as denoted by surface area 121 in FIG. 1A.

The piezoelectric material 102 can be a piezoelectric film that is coupled to surface area 120 of the layer of electrophoretic material 104 using a lamination process. In some embodiments, the piezoelectric material 102 is formed by depositing a piezoelectric material onto the layer of electrophoretic material 104. For example, surface area 120 of the layer of electrophoretic material 104 can be coated with a thin film of piezoelectric material, such as PVDF, using a spin-coating process or casting (e.g., slot-dye coating). In some embodiments, a film deposition process such as printing, spraying, or gravure coating is used to form the piezoelectric material 102 on the layer of electrophoretic material 104. In some embodiments, the resulting piezoelectric material 102 is less than 10 μm in thickness. In some embodiments, the resulting piezoelectric material 102 is about 3 μm in thickness.

The electrode 108 overlaps with or covers the piezoelectric material 102 and surface area 121 of the layer of electrophoretic material 104. The electrode 108 can be a conductive adhesive material (e.g., copper tape) that is applied over the piezoelectric material 102 and surface area 121 of the layer of electrophoretic material 104. In some embodiments, the electrode 108 is a metal film, such as a copper, silver, gold, or aluminum film or foil that is bonded to a flexible, light-transmissive substrate (not shown) such as a polymeric film. In some embodiments, the electrode 108 is an adhesive or tie layer comprising a transparent conductive material (e.g., a first electrically-conductive adhesive) including a conductive metal oxide, conductive polymer, and/or other suitable conductive agent that is coated onto a substrate (not shown). For example, a thin layer of electrically-conductive material can be directly-deposited (e.g., sputtered, vapor deposited) onto a suitable substrate, such as a polymer substrate (e.g., PET). In some embodiments, the electrode 108 is less than 5 μm in thickness. In some embodiments, the electrode 108 is between 1 and 3 μm in thickness. In some embodiments, the electrode 108 is less than 1 μm in thickness.

The first electrode, electrode 106, is bonded to the layer of electrophoretic material 104 on a surface opposite to the piezoelectric material 102 and electrode 108. For example, the electrode 106 can be laminated to the layer of electrophoretic material 104 to form a microcapsule- or microcell-based front plane laminate or FPL as described above in connection with U.S. Pat. No. 6,982,178.

The electrode 106 can be formed in advance on a substrate (not shown) using one of the processes described above with respect to the electrode 108. In some embodiments, the electrode 106 can be formed from an adhesive or tie layer comprising a transparent electrically-conductive material deposited on a substrate. The substrate can be a release sheet used temporarily to facilitate fabrication of the piezo-electrophoretic film. In some embodiments, the electrode 106 is less than 5 μm in thickness. In some embodiments, the electrode 106 is between 1 and 3 μm in thickness.

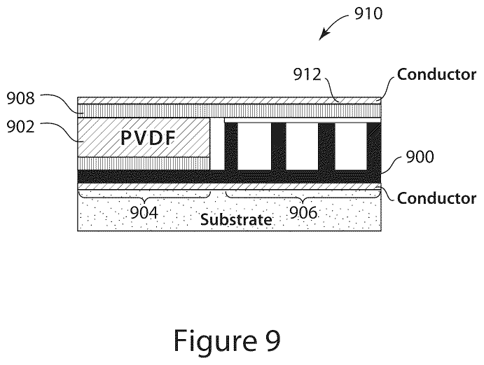

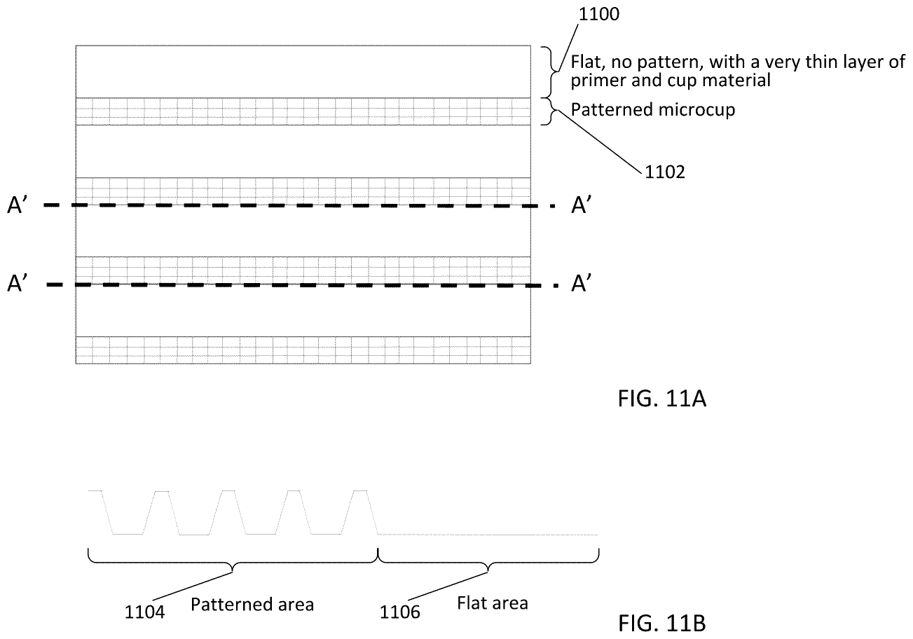

In some embodiments, the layer of electrophoretic material 104 is fabricated onto the electrode 106 before being bonded with the piezoelectric material 102 and electrode 108. For example, electrode 106 can be coated with an electrophoretic medium layer including a plurality of microcapsules containing a non-polar fluid and charged pigment particles (not shown in FIG. 1A). Alternatively, an electrophoretic medium layer comprising a plurality of microcell structures can be formed on the electrode 106. For example, an embossable microcell precursor material can be laminated to the electrode 106. Prior to lamination, the precursor material may be treated or coated with a microcell primer comprising, e.g., acrylates, vinyl ethers, or epoxides, as described in detail, for example, in U.S. Pat. Nos. 6,930,818, 7,052,571, 7,616,374, 8,361,356, and 8,830,561, all of which are incorporated by reference in their entireties. The microcell precursor is microembossed or photolithographed resulting in an open microcell structure that is subsequently filled with the desired electrophoretic medium and sealed with a sealing layer. (Embossing is described below in connection with FIGS. 9 and 11A-11B.) The open microcells may optionally be cleaned/activated with a vapor plasma treatment before the microcells are filled with the desired electrophoretic medium.

In some embodiments, the layer of electrophoretic material 104 is between 10 and 30 μm in thickness. In some embodiments, the layer of electrophoretic material 104 is about 15 μm in thickness.

In some embodiments, the electrode 106 may be segmented (not shown). As a result, the changes in gray tone caused by movement of the charged pigment particles in the layer of electrophoretic material 104 will appear to be segmented as well. Alternatively, the electrode 106 can comprise a single continuous sheet or film of conductive material, and the changes in gray tone will appear continuous. It should be appreciated that all of the layers (e.g., layers 102, 104, 106, 108) of display 100 can be fabricated to be transparent, such that the display 100 can be viewed from either orientation or direction.

In practice, the CR of the piezo-electrophoretic display 100 can differ depending on the ratio of surface area 120 (i.e., the surface area of the layer of electrophoretic material 104 that is overlapped or covered by the piezoelectric material 102) to surface area 121 (i.e., the surface area of the layer of electrophoretic material 104 that is overlapped or covered by the electrode 108). Experimental results of the CR are shown below in Table 1.

TABLE 1
Display CR vs. Piezo Film Surface Area

| Ratio of EPD film on | |
|---|---|
| piezo film to that | Response of display |
| on conductive adhesive | on strain change |
| 0 | Contrast ratio: 1.7 |
| 1:2 | Contrast ratio: 2 |
| 1:1 | Contrast ratio: 5 |
| 2:1 | Contrast ratio: 7 |

As shown in Table 1, increasing the ratio of surface area 120 with respect to surface area 121 can improve a display's CR. For example, display CR improves from a value of 2 when the ratio of surface area 120 to surface area 121 is 1:2, to a value of 7 when the ratio is 2:1.

In some embodiments, there is an adhesive layer (not shown) between the piezoelectric material 102 and the layer of electrophoretic material 104. In some embodiments, the adhesive layer has a resistivity between 10² ohm*cm and 10⁸ ohm*cm, and preferably less than 10¹² ohm*cm. In some embodiments, the adhesive layer has a resistivity that is at least one order of magnitude greater than the resistivity of the electrodes. Accordingly, the adhesive layer can have the resistivity properties of a semi-conductive material or a highly-resistive insulating material. In this configuration, the adhesive layer can function as a form of dielectric to prevent fast dissipation of locally-produced charges by the piezoelectric material 102, resulting in an improvement in the display's CR. Further, it was determined that reducing the width of either electrode 106 or electrode 108 and applying the physical stress vertically to the longer side of electrode 108 could further improve the CR of the display.

FIG. 1B is a schematic cross section illustrating additional properties of the piezo-electrophoretic display 100 shown in FIG. 1A in accordance with the subject matter disclosed herein. A first portion 132 of the layer of electrophoretic material 104 overlaps or is positioned adjacent to the piezoelectric material 102, and a second portion 134 of the layer of electrophoretic material 104 overlaps or is positioned adjacent to electrode 108, as delineated by dashed line 122. The first portion 132 and second portion 134 each have an electrical resistance that is based on the volume of the electrophoretic material they encompass. As denoted by the “+” and “−” symbols, a voltage has been generated by the charge separation that occurs within the piezoelectric material 102, for example, in response to bending or mechanical stress to the piezoelectric material 102.

FIG. 1C is a perspective view illustrating additional properties of the piezo-electrophoretic display 100 shown in FIG. 1A in accordance with the subject matter disclosed herein. For case of review, electrode 106 is not shown in FIG. 1C. As can be seen in FIG. 1C, the first portion 132 of the layer of electrophoretic material 104 overlaps the piezoelectric material 102 at or adjacent to the first surface area 120 (delineated by a dashed line), and the second portion 134 of the layer of electrophoretic material 104 overlaps the second electrode 108 at or adjacent to the second surface area 121 (delineated by a dashed line).

FIG. 2 illustrates an exemplary equivalent circuit 200 of the piezo-electrophoretic display 100 shown in FIGS. 1B and 1C in accordance with the subject matter disclosed herein. The three nodes or points, point ‘A’ near the piezoelectric material 102 and portion 132, point ‘B’ at the electrode 1 106, and point ‘C’ at the electrode 2 108, shown in FIG. 1B correspond to the same three points A, B, and C shown in equivalent circuit 200 of FIG. 2. Resistance R₁ corresponds to the electrical resistance of the first portion 132 of the layer of electrophoretic material 104, and resistance R₂ corresponds to the electrical resistance of the second portion 134 of the layer of electrophoretic material 104.

The layer of piezoelectric material 102 is represented as a battery in FIG. 2, and voltage V_{PZ} is the voltage generated by the piezoelectric material across points A and C. Resistance R₁ and resistance R₂ are represented in series because the presence of a voltage source beneath only a portion of the layer of electrophoretic material 104 effectively divides the layer into separate sections (as delineated by dashed line 122) having different electrical properties. For example, when voltage V_{PZ} has been generated, the voltage potential at point A is higher than at points B or C. Using a conventional current flow paradigm, current 201 flows from point A through resistance R₁ to point B, and from point B through resistance R₂ to point C. It follows that the voltage generated across resistance R₁ is opposite in polarity to the voltage generated across resistance R₂. In effect, two opposite voltages are created in series across separate portions of the layer of electrophoretic material 104.

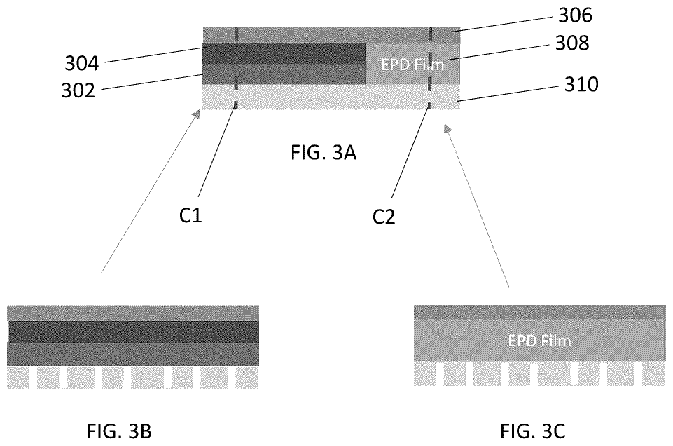

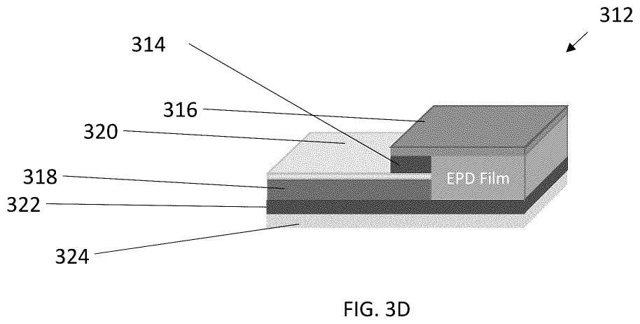

In another embodiment in accordance with the subject matter disclosed herein, instead of having a layer of piezoelectric material directly laminated onto or overlapping with an EPD film as shown in FIGS. 1A-1C, a piezo film 302 may be laminated onto a semi-conductive or high-resistive layer 304, and then the semi-conductive or high-resistive layer 304 can be laminated onto an electrode 1 layer 306, as shown in FIG. 3A. In this configuration, the semi-conductive or high-resistive layer 304 replaces portions of the EPD film 308 on top of the piezo film 302, thereby reducing the overall thickness of the display, as well as preventing a fast dissipation of charges across the piezo film 302 so the locally produced charges (by the piezo film 302) may be effectively and efficiently applied onto the EPD film 308, which results in an improvement in the display CR. Illustrated below in Table 2 is a comparison of the resistivity level of the semi-conductive layer 304 and the resulting CR. As shown, an optimum CR ratio of 12 may be achieved when the semi-conductive layer 304 has a resistivity of 10⁸ ohm*cm.

TABLE 2
Display CR vs. Resistance

| Resistivity of material | |
|---|---|
| in between electrode 1 | |
| and piezo film (Ohm * cm) | Response of display on strain change |
| 10² | Contrast ratio: 1.7 |
| 10⁸ | Contrast ratio: 12 |
| >10¹² | Contrast ratio: 1 (no response) |

Furthermore, display CR may be optimized by adjust the resistance value of the semi-conductive layer 304. For example, at a resistivity in the range of approximately 10⁸ (ohm*cm), a display CR of 12 may be achieved. In another embodiment, the resistivity of the electrode 1 layer 306 may be at approximately 450 ohm/sq, where the resistivity of an electrode 2 layer 310 may be at 0.003 ohm/sq, the EPD film 308 may have a resistivity of approximately 10⁷ to 10⁸ ohm*cm, and the piezo material 302 may have a resistivity of 10¹³ to 10¹⁴ ohm*cm.

FIGS. 3B and 3C are cross sectional views of the display illustrated in FIG. 3A. FIG. 3B shows the display cross-section along the C1 line and FIG. 3C shows the display cross-section along the C2 line. In practice, only the EPD portion 308 of the display may be made visible to a user, while the piezo film portion may be covered up. As also illustrated in FIGS. 3B and 3C, the electrode 2 layer 310 may be segmented. As a result, the changes in gray tone in the EPD film layer 308 will appear to be segmented as well. Alternatively, if the electrode 2 310 is a single continuous sheet, the change in gray tone in the EPD film layer 308 will be continuous as well. It should be appreciated that both electrode 1 306 and electrode 2 310 may be transparent, and all the layers (e.g., layers 302, 304, 310, etc.) may be transparent, such that the display can be viewed from either orientation or directions.

In another embodiment, FIG. 3D illustrates a cross sectional view of another display 312 in accordance with the subject matter presented herein. This display 312 differs from the display illustrated in FIG. 3A in that only a portion of the piezoelectric film layer 318 overlaps with the electrode 1 316 layer. In this configuration, the piezoelectric film layer 318 can avoid being placed in a neutral plane position, such that better images may be generated from the piezoelectric film 318. In addition, the piezoelectric film layer 318 may be a metalized piezo film and may be covered by a metal layer 320. In some embodiment, a first semi-conductive layer 314 may be positioned between the metal layer 320 and the electrode 1 layer 316. And another second semi-conductive layer 322 may be positioned between the piezoelectric film layer 318 and an electrode 2 layer 324. It should be appreciated that all the layers presented herein, including the electrode 1 316 and electrode 2 324 layers may be transparent, such that this display may be viewed from either direction or orientation.

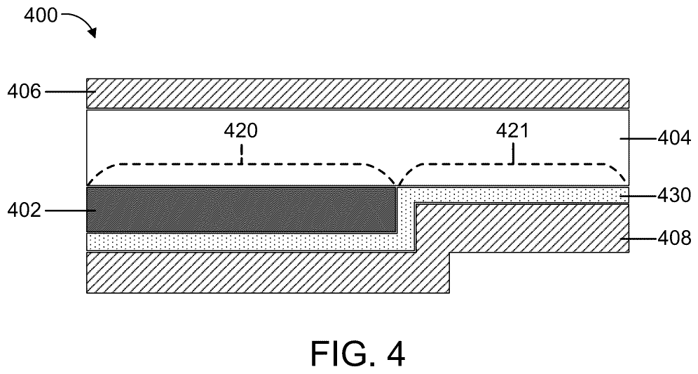

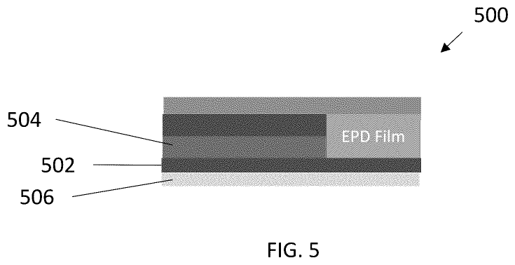

FIG. 4 is a schematic cross-sectional view of an exemplary piezo-electrophoretic display 400 in accordance with the subject matter disclosed herein. The configuration of display 400 is similar to that of display 100 illustrated in FIGS. 1A, 1B, and IC. For example, display 400 includes a piezoelectric material 402 overlapping or covering a first portion of the surface area of a layer of electrophoretic material 404, as denoted by surface area 420 in FIG. 4. However, display 400 includes a dielectric layer 430 that overlaps with all of the piezoelectric material 402, and a second portion of the surface area of the layer of electrophoretic material 404, as denoted by surface area 421 in FIG. 4. The electrode 408 of display 400 overlaps with all of the dielectric layer 430.

The dielectric layer 430 can be similar to the adhesive layer described in connection with display 100 of FIG. 1A. For example, the dielectric layer 430 can be formed from a material that has the resistivity properties of a semi-conductive material or a highly-resistive insulating material. In some embodiments, the dielectric layer 430 has a resistivity between 10² ohm*cm and 10⁸ ohm*cm, and preferably less than 10¹² ohm*cm.

The dielectric layer 430 functions to prevent charges generated by the piezoelectric material 420 from dissipating as quickly as they would if the piezoelectric material 420 was in direct contact with the electrode 408. This enables those charges to be more effectively and efficiently applied across the layer of electrophoretic material 404, thereby maximizing the movement of the charged pigment particles which in turn improves the display CR.

A comparison of the CR achieved between the various display designs is illustrated in Table 2 below. A first display fabricated such that the piezoelectric material was at least partially overlapping with or in contact with both electrodes achieved a CR of 1.7. As noted above, display 100 achieved a CR of 7 when the ratio of surface area 120 to surface area 121 was 2:1. Among the various configurations, the display 400 illustrated in FIG. 4 demonstrated the best CR performance at 18 when the resistivity value of the dielectric layer 330 was approximately 108 ohm*cm.

FIG. 5 illustrates another design of a display 500. This display 500 is similar to the one shown in FIG. 3A except an additional highly-resistive or semi-conductive layer 502 is placed between the piezoelectric layer 504 and the electrode 2 layer 506.

A comparison of the CR achieved between the various display designs is illustrated in Table 3 below. A first display fabricated such that the piezoelectric material was at least partially overlapping with or in contact with both electrodes achieved a CR of 1.7. As noted above, display 100 achieved a CR of 7 when the ratio of surface area 120 to surface area 121 was 2:1. Among the various configurations, the display 400 illustrated in FIG. 4 demonstrated the best CR performance at 18 when the resistivity value of the dielectric layer 330 was approximately 10⁸ ohm*cm.

TABLE 3
Comparative of CR among display configurations

| | Response of display on strain change |
|---|---|
| Piezo film directly contact | Contrast Ratio: 1.7 |
| with both electrodes | |
| FIG. 1 | Contrast Ratio: 7 |
| FIG. 3A | Contrast Ratio: 12 |
| FIG. 4 | Contrast Ratio: 18 |
| FIG. 5 | Contrast Ratio: 14 |

It should be appreciated that all of the layers of displays 400 and 500 can be fabricated to be transparent, such that the displays 400 and 500 can be viewed from either orientation or direction.

It should also be noted that, referring to the display configurations illustrated in FIGS. 1A-5, a conductive path is complete between the electrodes, the piezoelectric material, and the layer of electrophoretic material without requiring any other conductors or contacts to enable operation of the display. This advantageously reduces the overall thickness of the final piezo-electrophoretic display device, while also improving the CR ratio of the display.

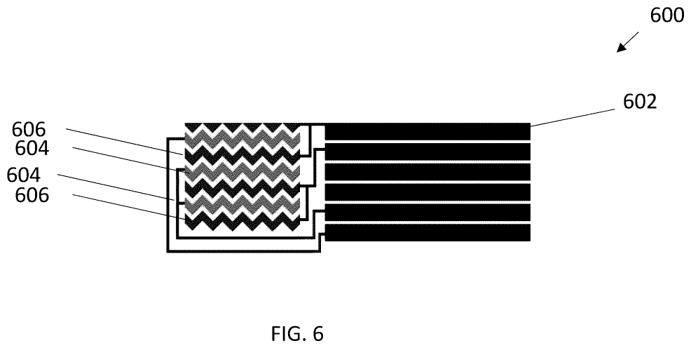

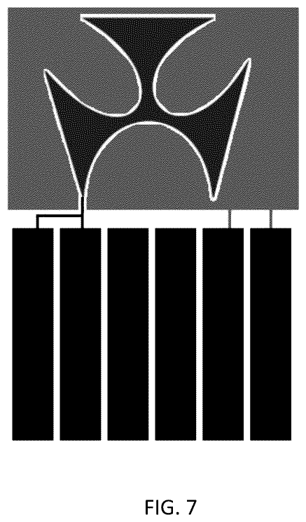

FIGS. 6 and 7 illustrate embodiments of piezo electrophoretic displays that may be configured to display various patterns, such as the jigsaw pattern in FIG. 6 and the star shaped pattern in FIG. 7. In FIG. 6, a display 600 may include a plurality of electrodes 602 design to transport charges to electrophoretic display mediums 604s and 606s. In the embodiment illustrated in FIG. 6, the display medium 604 is of red color and the display medium 606 is of black color. It should be appreciated that other colors may be conveniently adopted. In this configuration, electrodes 602 on the top portion of the display may be connected to the black colored display mediums 606, and the electrodes 602 of the bottom portion may be connected to the red colored display mediums 604. In use, when a force is being applied to the display 600, the display mediums 606 and 604 may display both the black and red color. This particular configuration illustrated in FIG. 6 can be printed using conductive material, greatly simplify the manufacturing process.

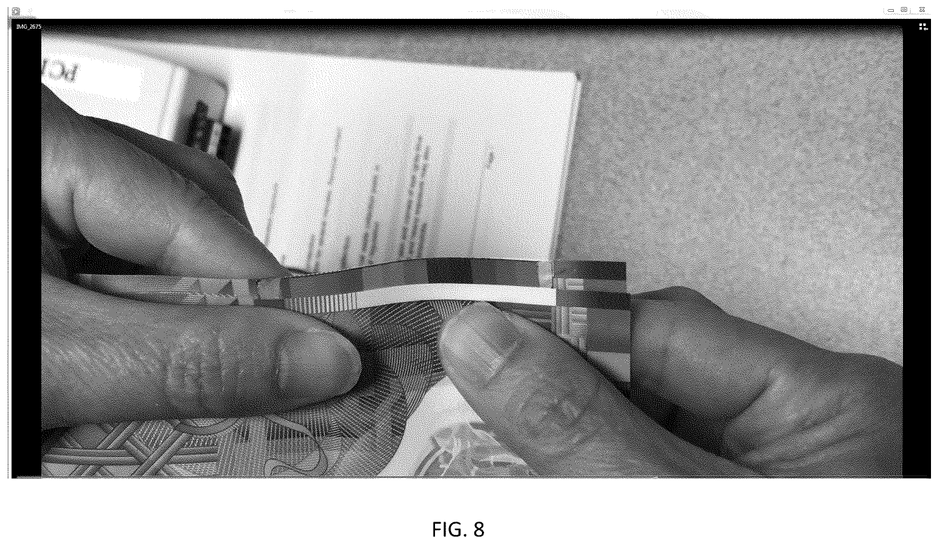

In some other embodiments, a piezo electrophoretic display in accordance with the subject matter disclosed herein may be combined with another apparatus, such as a currency bill illustrated in FIG. 8. In this embodiment, a display may be affixed to one end of a bill, and when physical stress is applied, the display can switch between one or more graytones. In this fashion, a user may easily distinguish a genuine bill from a counterfeiting one. As mentioned above, the electrodes for the display may be segmented, and the resulting gray tone of the EPD material layer may appeal segmented. Alternatively, the electrodes for the display may be a continuous sheet, and the resulting gray tone of the EPD material may vary in a continuous fashion.

### Methods of Manufacturing

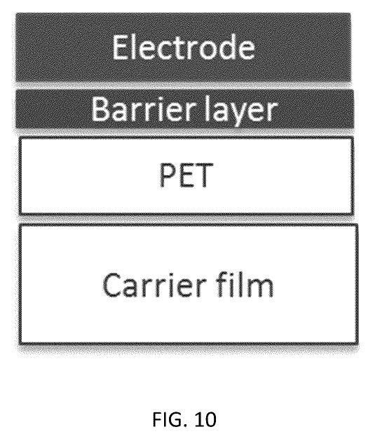

FIG. 9 illustrates a cross sectional view of yet another embodiment of a piezoelectric display 910 in accordance with the subject matter presented herein. As shown in FIG. 9, the EPD layer 900 may partially extend underneath a piezo-electric material 902 to substantially overlap and ensuring a secured connection with the piezo-electric material 902. In this embodiment, the EPD layer 900 may have one portion having micro-cells 906 and another portion that is substantially flat 904 and configured for establishing a connection with the piezoelectric material 902. In this configuration, the piezo-electric material 902 is positioned to overlap on the substantially flat portion 904, ensuring a good connection with the EPD layer 900. This configuration can advantageously establish a strong connection between the piezo-electric material 902 and the EPD layer 900. For example, this configuration offers a robust connection between the piezo-electric material 902 and the EPD layer 900 that is capable of withstanding repeated bending or applied stress onto the display device 910. Additionally, an adhesive layer 908 may be placed between the piezoelectric material layer 902 and the conductor 912. In another embodiment, the piezoelectric material 902 can be circular in shape and surrounds the EPD material 900. Furthermore, as illustrated in FIG. 9, the piezo-electric material 902 and the EPD layer 900 may be sandwiched between two layers of conductors or conducting materials, and all the above mentioned layers and material may be positioned on a substrate that can be flexible. It is preferred that the substrate be less than 10 micron in thickness to make the overall device thin. In some embodiments, ITO/PET may be used herein as substrate. In some other embodiments, flexible and transparent conductive coatings may be used, such as PEDOT:PSS, graphene, carbon nanotubes or silver nano wires. In yet some other embodiments, a barrier layer may be sputtered onto the substrate layer (e.g., PET) before coating the conductive layer to provide a barrier to the ink solvent, as shown in FIG. 10. In some cases, this barrier layer may be SiOx. Since the substrate in this case is thin, the barrier layer may also be coated onto the other side of the substrate. Additionally, other optical layers may be printed onto the substrate for decoration purposes. In some embodiments, the carrier film may be discarded after the display have been assembled. And the rest of the display, without the carrier film, may be integrated with other structures. It should be appreciated that all the layers presented herein, including the electrode 1 and electrode 2 layers may be transparent, such that this display may be viewed from either direction or orientation.

FIG. 11A illustrates a top view of the EPD layer 900 of FIG. 9. As shown, the EPD layer 900 may be manufactured by pattern micro-cell structures onto only portions of the layer 900, while leaving the other portion substantially flat. In this fashion, the substantially flat portions 1102 without the micro-cells (i.e., a separate portion 1102 is designated to have microcell structures) may be used to create connections with the piezo-electric layer as shown in FIG. 9. This method of manufacturing offers several advantages. Firstly, it is easier to fabricate the EPD layer in this fashion, where the contacting portion (i.e., the substantially flat portion) and the micro-cell portion 1102 are fabricated at the same time, compared to an alternative method where the fabrication of the two portions are done separately. Secondly, as the substantially flat contact portion 1100 and the micro-cell portion 1102 are fabricated together, they are more robust structurally, which leads to a better connection between the EPD layer and the piezo-electric layer, as well as a more durable display device. FIG. 11B illustrates a cross sectional view of the EPD layer as shown in FIG. 11A. The EPD layer may include a first portion 1104 with micro-cells patterned and a flat portion 1106 with no micro-cells. In practice, the substantially flat portion 1106 and the micro-cell portion 1104 may be patterned at the same photolithography step. In some embodiments, once the patterns have been defined, and after an embossing step, strips of release liners may be laminated on to the substantially flat portion, where the thickness of the release liner may be the same of the micro-cell height. It is preferred that the surface energy of the release liner to be sufficiently high such that the sealing layer will not de-wet on the top of the release liner, and in some embodiments, the surface energy may be tuned to a particular level depending on the application. The release liner in this case may include poly vinyl alcohol or other water soluble polymers. Furthermore, after a filing and sealing step, the release liner may be removed together with the ink and sealing layer on top of it to expose the flat area underneath. In practice, removing the release liners will remove the sealing layer/material and ink from the substantially flat portion of the EPD layer. This process can ensure a substantially clean break of the ink and sealing material from the micro-cell portion 1104. A piece of non-metalized piezo film may be laminated onto the flat. The total thickness of piezo film and adhesive layer may be similar to the total thickness of the scaling layer and the micro-cells. In addition, a piece of adhesive layer may be laminated onto the release liner and onto the full display panel. A in line humidification or off line chamber humidification step may be used to ensure good optical performance of the display. In practice, after the patterns have been defined in FIGS. 11A and 11B, the structure may be cut along the A′A′ line to create displays.

In some embodiments, a method for producing a display as describe above may include producing a layer of electrophoretic display material having a first portion 1102 and a second portion 1100, the first portion 1102 having a plurality of micro-cells and the second portion 1100 being substantially flat. The method may further include providing a piezoelectric material, and aligning the piezoelectric material to the second portion of the electrophoretic display material such that the piezoelectric material substantially overlaps with the second portion. In some embodiments, the first 1102 and second 1100 portions of the electrophoretic material are produced using a single photolithography step. The method may further include placing the electrophoretic display material and the piezoelectric material onto a substrate, where the substrate may be flexible. In some embodiments, the method may further include providing a conductive electrode onto the substrate, and providing a barrier layer between the conductive electrode and the substrate. In some embodiments, after the producing a layer of electrophoretic display step, the method may further include providing a layer of release liner, where the release liner has a height that is substantially similar to that of the plurality of micro-cells.

Furthermore, another second electrode may be printed on top of the substrate as shown in FIG. 6. To connect the second electrode to the EPD material, conducive ink may be used to pattern conductive traces or lines. In some embodiments, the pattern may contain two portions. A first portion may be printed as small strips and a second portion may be a two pixel pattern. Where each pixel may be connected to one or two small stripes suing conductive ink. These patterns may then be subsequently aligned and laminated onto the above mentioned FPL with the piezoelectric film on top of the small stripes.

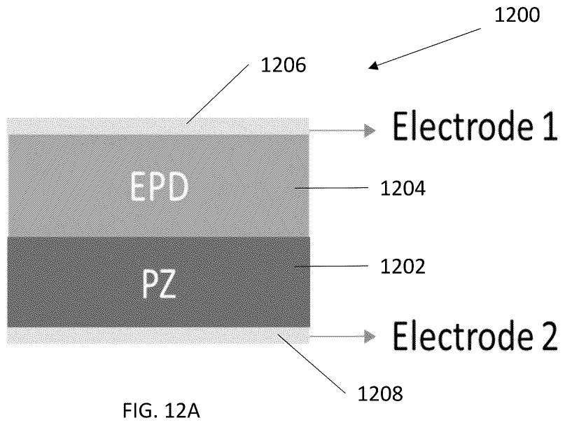

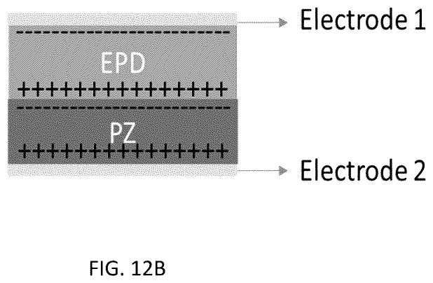

FIGS. 12A and 12B illustrate another embodiment of an electrophoretic display 1200 utilizing piezoelectric material. As shown, a piezoelectric material layer 1202 may be stacked with a display medium layer 1204 (e.g., an electrophoretic medium layer) to form a display. Two electrodes, electrode 1 1206 and electrode 2 1208 may be positioned on the two sides as shown in FIGS. 12A and 12B to sandwich the EPD layer 1204 and the piezoelectric material layer 1202 to complete a conductive path for the charges. In some embodiments, the electrode 2 1208 may be a metal on piezoelectric film or a laminated conductive adhesive on piezo film. In this configuration, no other connections is needed to drive the electrophoretic display material 1204.

In use, when a force is applied onto the piezoelectric material layer 1202, charge separation occurs within the piezoelectric material 1202. The charge on the interface of the electrophoretic display medium layer 1204 and the piezoelectric material layer 1202 can induce the charges on the EPD film and the electric field passes through the EPD to make the particles move. FIG. 12B illustrates a view of the charge distribution.

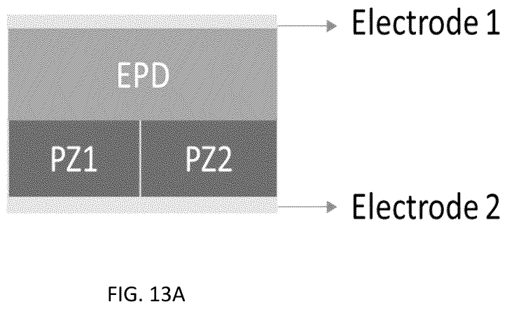

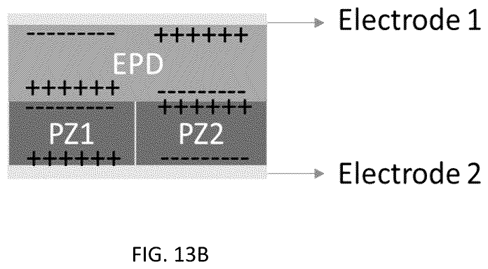

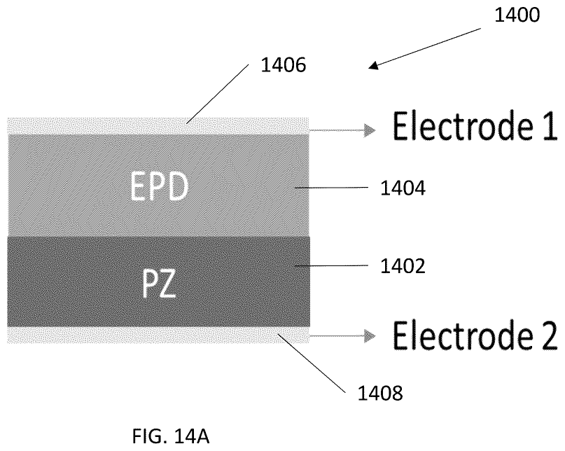

In yet another embodiment, to achieve an even better contrast ratio, piezo films with opposite poling directions may be positioned in a side by side configuration, as illustrated in FIGS. 13A and 13B. In use, PZ1 and PZ2 can produce opposite voltages under an applied force, FIG. 13B shows one embodiment of charge distribution when force is applied. It should be appreciated that all the layers presented herein in FIGS. 12A-13B, including the electrode 1 and electrode 2 layers may be transparent, such that this display may be viewed from either direction or orientation.

The embodiments shown in FIGS. 12A-13B not only reduces the overall device thickness to be less than 50 micro-meters, but also vastly improve the CR. It furthermore simplifies the device structure and makes the display device more sensitive to small strain changes.

### Latent Images

Displays fabricated according to the subject matter herein can be used to display hidden or so-called “latent” images. In particular, images (e.g., shapes, text, barcode, etc.) can be laminated or printed onto either electrode of a display such that the image is only visible upon movement of the charged pigment particles in response to voltage generated by bending or introducing other mechanical stress to the piezoelectric material.

In some embodiments, an image is printed or laminated onto one of the electrodes on a white background, and the display is viewed from the electrode on the opposite side. When the display is showing a white color (e.g., the white pigment particles are positioned closest to the electrode that does not have the image printed on it), the printed image is obscured or hidden. However, when the positions of the pigment particles shifts in response to mechanical stress to the piezoelectric material, the white pigment particles move away from the viewing surface while pigment particles of another color (typically a darker color) move toward the viewing surface, thereby allowing the image to be displayed.

In another embodiment, a dark-colored image is printed or laminated onto one of the electrodes with no background color, and the display is again viewed from the electrode on the opposite side. In this embodiment, when the display is held in front of a dark or black background, the image remains substantially obscured or hidden regardless of whether the display is displaying white or another color. However, when the display is held in front of a light or white background, the image becomes visible. For this embodiment, the image is becomes visible when the display is displaying white, but is more clearly visible when the display is displaying a darker color.

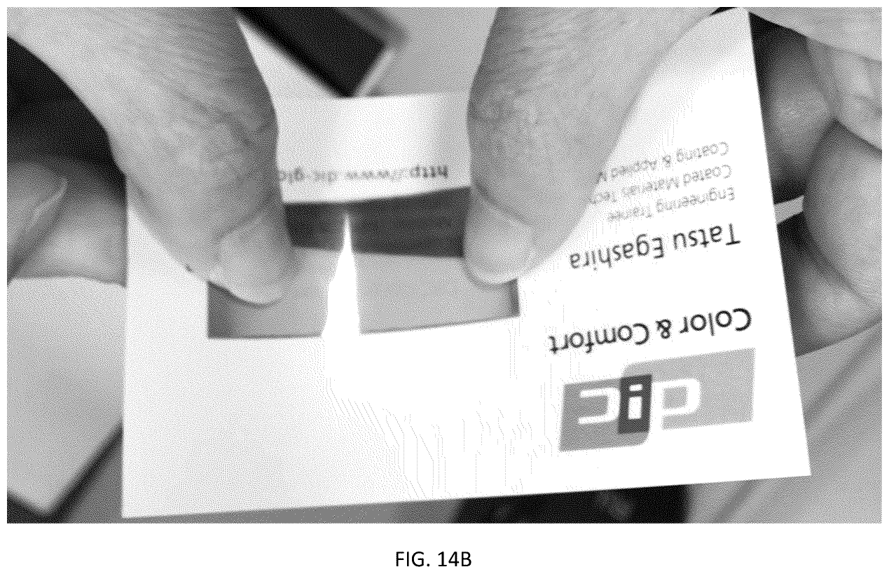

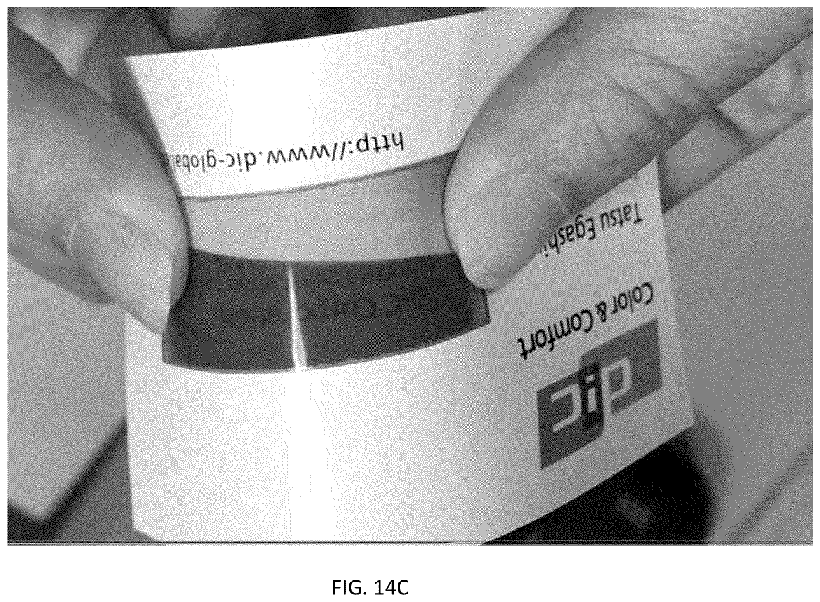

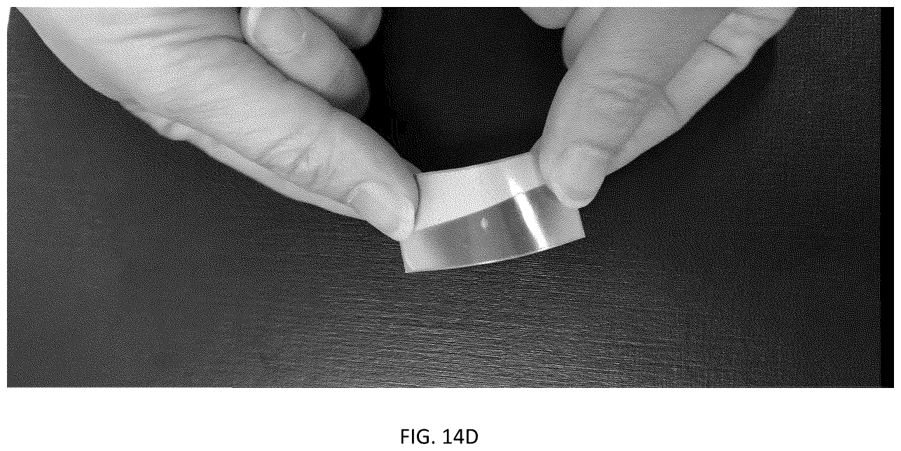

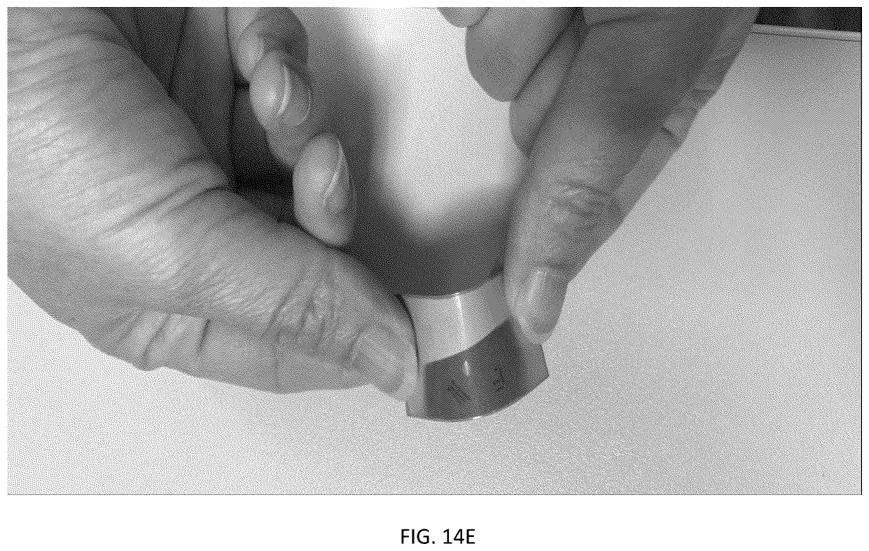

In some embodiments, displays with structures that's similar to or based on the configurations illustrated in FIG. 12A or FIG. 1 may be modified to display latent images. Illustrated in FIG. 14A is a display device 1400 similar to the one presented in FIG. 12A, but with images or shapes laminated or printed onto either the electrode 1 1406 or electrode 2 1408. It should be appreciated that the configuration presented in FIG. 14A is for illustrating the concept as other configurations can be easily adopted to achieve the same effect. In practice, every layer of the display 1400 may be transparent (e.g., layers 1402, 1404, 1406, 1408, etc.), even the adhesive layers and the electrodes 1 and 2 layers, such that this display can be viewed from either direction or orientation.

In some embodiments, images or shapes may be printed or laminated onto a white background and onto either the electrode 1 1406 or electrode 2 1408, and viewed from an opposite side. In use, when the EPD layer 1404 is showing white color, the printed image or shape will be hidden (i.e., see FIG. 14B), and when the EPD 1404 switches to another color when force is applied, the printed image or shape may be displayed (i.e., see FIG. 14C).

In yet another embodiment, dark colored images or shapes may be produced onto either electrode 1 1406 or electrode 2 1408 without a background and be viewed from an opposite side. In this configuration, when the display 1400 is position over a black background, as illustrated in FIG. 14D, the printed image or shape will remain hidden no matter how the EPD 1404 is bend. Alternatively, when the display 1400 is positioned over a white or light colored background, the printed image or shape will show up and it is more obvious when the EPD 1404 switches to a darker color, as illustrated in FIG. 14E.

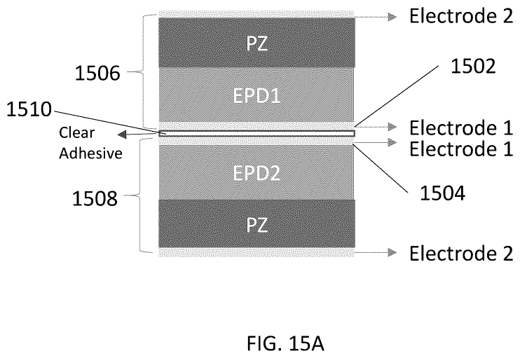

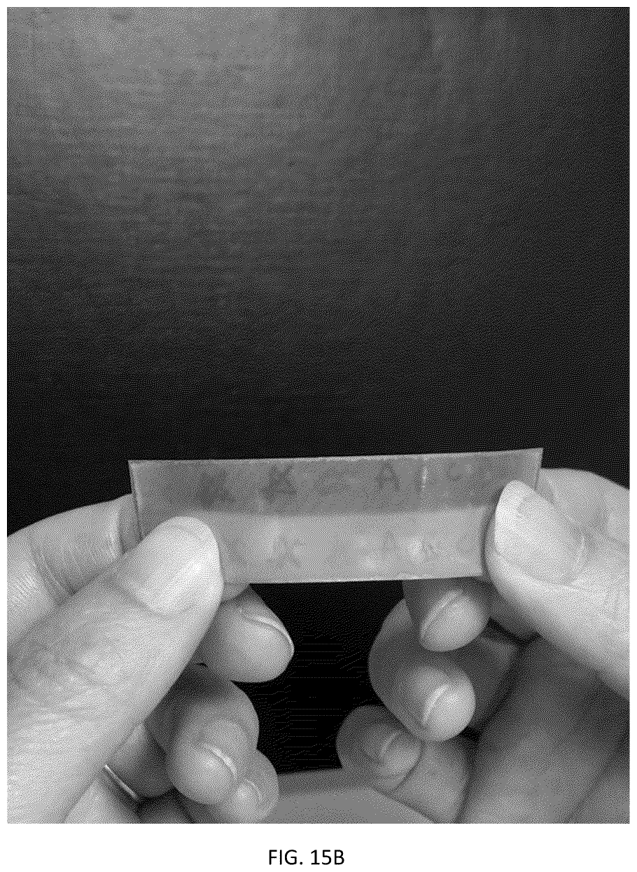

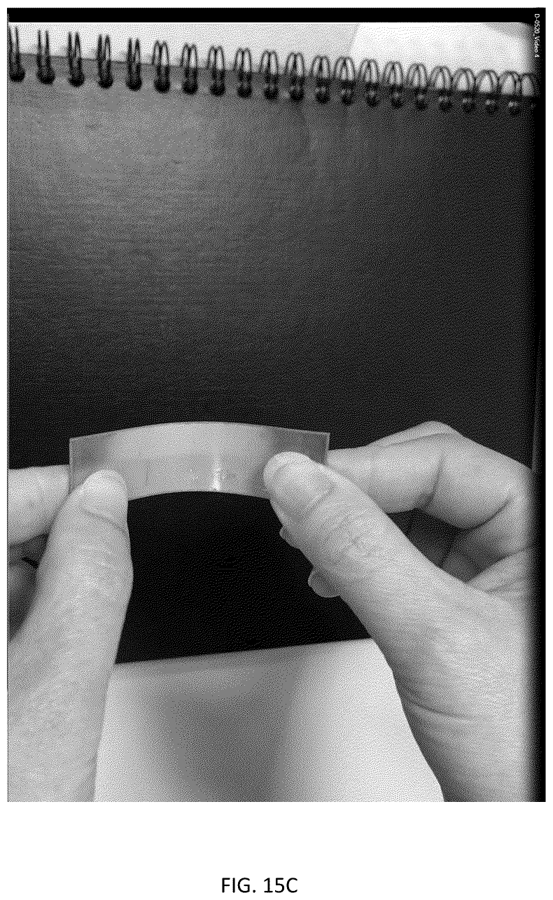

In yet another embodiment, as illustrated in FIG. 15A, images or shapes may be produced outside electrode 1s 1502, 1504 or either EPD display 1 1506 and EPD display 2 1508. The two EPD displays 1506, 1508 may be integrated together using a transparent adhesive material. When force is applied (e.g., bending), both EPD display 1 1506 and EPD display 2 1508 can change color. When EPD display 2 1508 turns dark and EPD display 1 1506 turns white, the printed image or shape will not show up, as illustrated in FIG. 15C. Alternatively, when EPD display 2 1508 turns white and EPD display 1 1506 turns dark, the printed image or shape will surface, as illustrated in FIG. 15B.

It should also be noted that, referring to the display configurations illustrated in FIGS. 9-14A, a conductive path is complete between the electrode 1 and electrode 2 and the piezoelectric material layer and the EPD film layer, no other conductor or electrodes is needed between the electrode 1 and electrode 2. And in the case of the display illustrated in FIG. 15, no additional conductor or electrode is needed for each of the stacked displays 1506 and 1508. This effectively reduces the overall thickness of the device, as well as improves the CR ratio of the display.

Piezo-electrophoretic displays produced as described above can be affixed to a low-profile object such as a currency bill or bank note. Accordingly, an image can be integrated into the bill such that a user may easily distinguish a genuine bill from a counterfeit bill based on how the optical state of the display changes (or does not change) as the bill is bent or flexed.

The display configurations described herein enable fabrication of a fully-functioning piezo-electricity driven display device having a thickness less than 50 μm. Further, the structure of the displays described herein is greatly simplified and makes the resulting display more sensitive to smaller applied physical stresses.

Accordingly, fabricating a piezo-electrophoretic display having the structure described herein provides advantages over conventional piezo-electrophoretic displays. For example, the piezo-electrophoretic displays described herein provide an improved means to drive the oppositely-charged pigment particles in the electrophoretic medium in different directions from one another without requiring a matrix of individually-addressable pixel electrodes. Therefore, piezo-electrophoretic displays produced as described herein can be made thin enough for use in applications requiring them to be durable and substantially unnoticeable when incorporated into thin, low-profile final products such as paper or bank notes while still providing a high contrast ratio between the different portions of the layer of electrophoretic material due to the effects described above.

It will be apparent to those skilled in the art that numerous changes and modifications can be made to the specific embodiments of the invention described above without departing from the scope of the invention. Accordingly, the whole of the foregoing description is to be interpreted in an illustrative and not in a limitative sense.

1. A method for making a piezo-electrophoretic display, the method comprising:
depositing a first electrically-conductive material on a first substrate to form a first electrode;
bonding the first electrode with a first surface of a layer of electrophoretic material;
depositing a piezoelectric material on a second surface of the layer of electrophoretic material, wherein the piezoelectric material overlaps with a first surface area of the second surface of the layer of electrophoretic material; and
depositing a second electrically-conductive material to form a second electrode, wherein the second electrode is formed to overlap with all of the piezoelectric material and a second surface area of the second surface of the layer of electrophoretic material.

2. The method of claim 1 wherein the layer of electrophoretic material comprises:
a first portion of electrophoretic material overlapping the first surface area; and
a second portion of electrophoretic material overlapping the second surface area.

3. The method of claim 2 wherein the first portion of electrophoretic material comprises a first electrical resistance and the second portion of electrophoretic material comprises a second electrical resistance.

4. The method of claim 3 wherein a value of the first electrical resistance and a value of the second electrical resistance are based on a ratio of the first surface area to the second surface area.

5. The method of claim 3 wherein applying mechanical stress to the piezoelectric material generates a first voltage across the first portion of the electrophoretic material and a second voltage across the second portion of the electrophoretic material, wherein the first voltage and the second voltage have opposite polarities.

6. The method of claim 1 wherein the layer of electrophoretic material comprises:
a first portion of electrophoretic material having a first electrical resistance corresponding to a first volume of electrophoretic material overlapping the first surface area; and
a second portion of electrophoretic material having a second electrical resistance corresponding to a second volume of electrophoretic material overlapping the second surface area.

7. The method of claim 6 wherein a value of the first electrical resistance and a value of the second electrical resistance are based on a ratio of the first surface area to the second surface area.

8. The method of claim 6 wherein applying mechanical stress to the piezoelectric material generates a first voltage across the first portion of the electrophoretic material and a second voltage across the second portion of the electrophoretic material, wherein the first voltage and the second voltage have opposite polarities.

9. The method of claim 1 wherein bonding comprises:
coating the first electrode with a microcell precursor material;
embossing the microcell precursor material to create a layer of microcells, wherein the microcells have a bottom, a plurality of walls, and a top opening;
filling the microcells with an electrophoretic medium through the top opening; and
sealing off the top opening of the filled microcells with a water-soluble polymer to create a sealing layer.

10. The method of claim 9 further comprising applying a primer to the microcell precursor material before embossing the microcell precursor material.

11. The method of claim 10 further comprising activating the microcells with a vapor plasma treatment before filling the microcells with the electrophoretic medium.

12. The method of claim 9 wherein the electrophoretic medium comprises a non-polar fluid and charged pigment particles that move toward or away from the piezoelectric material when the piezoelectric material is mechanically stressed, wherein the non-polar fluid and charged pigment particles are sealed in the microcells with the sealing layer.

13. The method of claim 1 further comprising applying a layer of adhesive material between the piezoelectric material and the first surface area of the second surface of the layer of electrophoretic material, wherein the layer of adhesive material has a resistivity between 10² ohm*cm and 10¹² ohm*cm.

14. The method of claim 1 further comprising applying a layer of adhesive material between the piezoelectric material and the first surface area of the second surface of the layer of electrophoretic material, wherein the layer of adhesive material has a resistivity at least one order of magnitude greater than the first and second electrodes.

15. The method of claim 1 further comprising depositing a dielectric layer prior to depositing the second electrically-conductive material, wherein the dielectric layer is formed to overlap with all of the piezoelectric material and the second surface area of the second surface of the layer of electrophoretic material, and wherein the second electrode is formed to overlap with all of the dielectric layer.

16. The method of claim 15 wherein the dielectric layer has a resistivity between 10² ohm*cm and 10¹² ohm*cm.

17. The method of claim 15 wherein the dielectric layer has a resistivity at least one order of magnitude greater than the first and second electrodes.

18. The method of claim 1 further comprising printing one or more images onto at least one of the first electrode and the second electrode.

19. The method of claim 1 further comprising affixing the piezo-electric display to a target object chosen from the group consisting of paper, a bank note, and a currency bill.
